(19) United States
(12) Patent Application Publication
(10) Pub. No.: US 2005/0259772 A1
(43) Pub. Date: Nov. 24, 2005

(54) Circuit arrangement and method to provide error detection for multi-level analog signals, including 3-level pulse amplitude modulation (PAM-3) signals

(75) Inventor: Martti Voutilainen, Espoo (FI)

Correspondence Address: HARRINGTON & SMITH, LLP, 4 RESEARCH DRIVE, SHELTON, CT, 06484-6212, US

(73) Assignee: Nokia Corporation, Espoo (FI)

(21) Appl. No.: 10/852,636

(22) Filed: May 24, 2004

(51) Int. Cl. H04L 7/00

(52) U.S. Cl. 375/353

(57) ABSTRACT

A mobile device (10) includes a plurality of sub-assemblies coupled together by a plurality of data communication buses (22) connected to ports (20). At least one port includes a Multi-level Analog Signaling (MAS) circuit arrangement that includes a transmitter (20A) to encode data bits represented by multi-level analog signals. A data communications bus that couples the transmitter to a receiver (20B) in another port includes at least one multi-level, possibly differential signal buses for conveying the encoded data bits such that such that, on each multi-level signal bus, during each data bit period the signal level is required to change from a signal level of an immediately preceding data bit period. The receiver includes a circuit (32) for generating a clock signal from received encoded data bits such that there is at least one clock edge per data bit period and a circuit (34A, 34B, XOR1, XOR2, OR, AND) to detect an occurrence of an erroneously generated clock edge by detecting that the signal level remains the same for two consecutive data bit periods. The AND circuit operates to inhibit the propagation of an erroneously generated clock edge.

### TECHNICAL FIELD

This invention relates generally to asynchronous communications links that use multi-level analog signaling and, more specifically, relates to multi-level pulse amplitude modulation (PAM), in particular PAM-3 (PAM with three amplitude levels), and even more specifically relates to the use of the PAM-3 technique for communication between logical entities within a device, such as a mobile communications device.

### BACKGROUND

Multi-level analog signaling (MAS) is used in Ethernet (10 Gigabit Ethernet) and other applications. Various MAS techniques include T-Waves, Quadrature Amplitude Modulation (QAM) and, of most interest to this invention, PAM, in particular PAM-3 (other PAM techniques, such as PAM-5, are also known in the art). In general, the transmission of different amplitude levels over a serial asynchronous link can be used to reduce electromagnetic interference and other problems, and is a well-known technique.

Exemplary publications of interest include: (a) IEEE Journal of Solid State Circuits, Vol 29, No 9, September 1994: Crister Svensson and Jiren Yuan, “A 3-Level Asynchronous Protocol for a Differential Two-Wire Communication Link”, where in the 3-level signaling method the symbol 0 is represented by a change from state S(i) to S(I+1), and the symbol 1 is represented by a change from state S(i) to S(I−1); and (b) “Ternary Physical Protocol for Marilan, A Multiple-Access Ring Local Area Network”, R. J. Kaliman et al., Electrical Engineering Dept., Univ. of Maryland, College Park, Md., pp. 14-20, 1988, where FIGS. 4(a) and 4(b) show symbol encoding examples for an exemplary binary sequence and a ternary non-return to zero (NRZ) representation thereof, respectively.

Communication between two logical entities or peripherals (within the same device) is typically accomplished via a dedicated interface, which may be a parallel or a serial interface. Such interfaces have been implemented using CMOS-based single-ended or low voltage differential signaling (LVDS)-based signaling. The dedicated interface can be defined as a physical connection between devices and a protocol, which is assumed to be known at both devices.

A general reference with regard to LVDS is Application Note 971, “An Overview of LVDS Technology”, AN-971, Syed B. Huq and John Goldie, National Semiconductor Corporation (1998).

When using at least some types of MAS, such as when one uses PAM-3 signaling, every symbol transmitted is different than the previously transmitted symbol. In PAM-3 the possible values are 0, ½ and 1. The ½ (middle amplitude value) is used to inform the receiving circuit that the newly received symbol is the same as the most recently received previous symbol. As a result of the use of this technique consecutive signal levels are guaranteed to be different. However, in asynchronous signaling, where PAM-3 type signaling is typically used, the false triggering of a bit is a most probable source of error, particularly in noisy environment such as those experienced by mobile terminals, such as cellular telephones, personal communications and wireless internet appliances.

Prior to this invention, there was no low cost, low pin count, low power and non-complex technique to provide for single bit error detection in a PAM channel, such as a PAM-3 channel.

### SUMMARY OF THE PREFERRED EMBODIMENTS

The foregoing and other problems are overcome, and other advantages are realized, in accordance with the presently preferred embodiments of these teachings.

A mobile device includes a plurality of sub-assemblies coupled together by a plurality of data communication buses connected to ports. At least one port includes a MAS circuit arrangement that includes a transmitter to encode data bits represented by multi-level analog signals. A data communications bus that couples the transmitter to a receiver in another port includes at least one multi-level, possibly differential signal buses for conveying the encoded data bits such that such that, on each multi-level signal bus, during each data bit period the signal level is required to change from a signal level of an immediately preceding data bit period. The receiver includes a circuit for generating a clock signal from received encoded data bits such that there is at least one clock edge per data bit period and a circuit to detect an occurrence of an erroneously generated clock edge by detecting that the signal level remains the same for two consecutive data bit periods. The circuit further operates to inhibit the propagation of an erroneously generated clock edge.

Also disclosed is a related MAS method, and a circuit arrangement for carrying out the method.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1A is a simplified block diagram of a mobile device having sub-assemblies connected by buses via ports;

FIG. 1B shows a dual differential bus connecting two of the ports of FIG. 1A and having a D0 (Master), D1 configuration;

FIGS. 2A and 2B, collectively referred to herein as FIG. 2, are signal waveform diagrams that illustrate, in FIG. 2A, a ternary (PAM-3) NRZ (Non-Return to Zero) line coding and a recovered clock signal for an ideal, noiseless reference case, and in FIG. 2B, the PAM-3 NRZ line coding and the recovered clock signal for a typical received signal that exhibits noise;

FIG. 3 is a simulated waveform diagram that illustrates amplitude sampling points at 0.65 x minimum bit period after the signal has passed the half amplitude point of the signal swing, where the waveform was simulated using an accurate transmission line model and ideal voltage comparator;

FIG. 4 is a diagram that shows a voltage and timing diagram of a PAM-3 driver for one bit period;

FIG. 5 is a schematic diagram of a PAM-3, or other MAS signaling technique receiver that includes an embodiment of an error detection circuit in accordance with this invention;

FIG. 6 is a schematic diagram of an embodiment of a toggle flip-flop that forms a part of the error detection circuit of FIG. 5;

FIG. 7 is a schematic diagram of an embodiment of an edge detection and event generation circuit that forms a part of the error detection circuit of FIG. 5; and

FIG. 8 is a schematic diagram of an embodiment of a dual-rail to binary converter circuit that forms a part of the error detection circuit of FIG. 5.

### DETAILED DESCRIPTION OF THE PREFERRED EMBODIMENTS

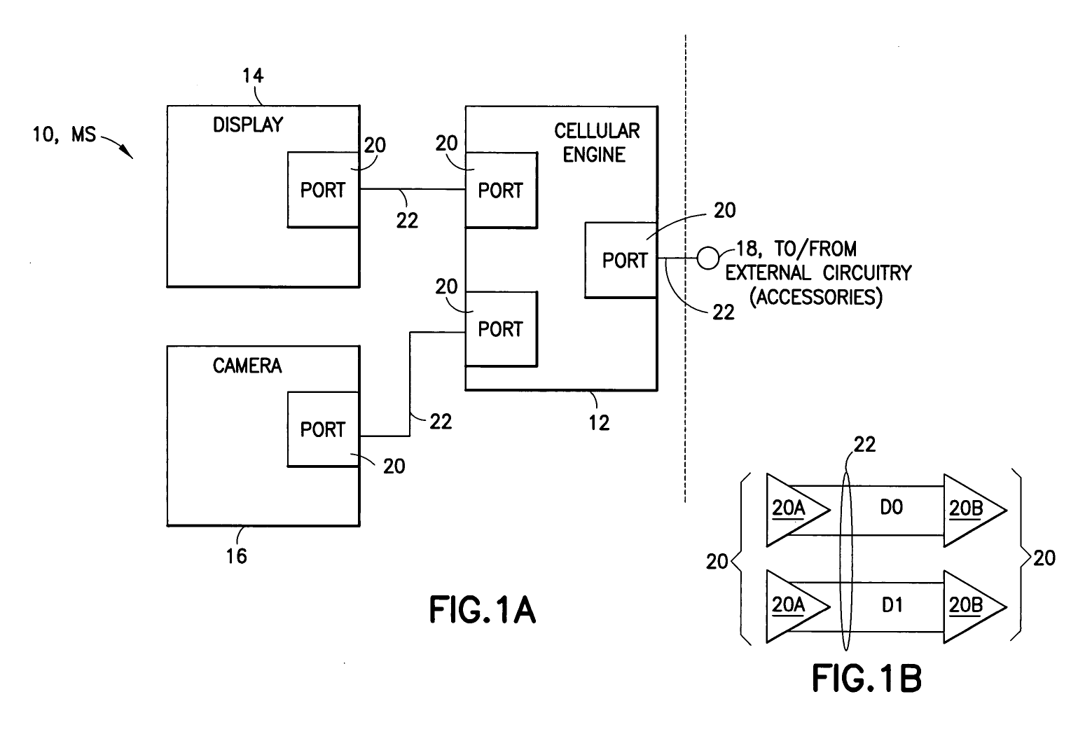

FIG. 1A is a simplified block diagram of a mobile station or mobile device 10 such as, but not limited to, a cellular telephone, a personal communicator, a personal digital assistant (PDA), or a mobile Internet terminal or appliance, or a device having a combination of such functionality (e.g., a PDA having cellular communication capabilities). The mobile device 10 has a plurality of sub-assemblies such as, by example, a cellular engine 12, a display 14 and a camera 16 that are connected by buses 22 (implemented with cables or stripline pairs) via ports 20. The cellular engine 12 may also be coupled to external components, such as an accessory or accessories 18, via another port 20 and bus 22.

It should be noted that the embodiment of FIG. 1A is exemplary, in that there may be more than or fewer than the illustrated number and types of sub-assemblies. Furthermore, in another embodiment a hub architecture may be employed, where the ports 20 and buses 22 are arranged into a signal line concentrator such that, as an example, the display 14, camera 16 and cellular engine 12 would each be connected together via a hub sub-assembly (the cellular engine 12 may in this case have only one port 20 for connection to the hub, instead of the three ports 20 illustrated in FIG. 1A).

In the preferred embodiment the ports 20 and buses 22 are based on a Multi-level Analog Signaling (MAS) technique, in particular a PAM-3 technique, where every symbol transmitted contains information of at least one bit.

FIG. 1B shows a presently preferred embodiment of a dual differential bus 22 connecting two of the ports 20 of FIG. 1A that have a D0 (Master), D1 configuration. That is, the presently preferred embodiment of the bus 22 uses four signal lines configured as two differential line pairs for data transfer using PAM-3 signaling. The first pair of lines, and the associated driver amplifiers 20A and receiver amplifiers 20B, can be denoted as D0 or as the “master”, while the other can be denoted as D1 or as a “slave”.

Note that the multi-level signal bus 22 need not be a differential bus, and that single-ended, multi-level bus embodiments can be employed as well to implement the teachings of this invention.

In the preferred embodiment the data is transmitted in frames. One suitable frame size, when using the two differential pairs for the bus 22, is 28 bits, where 24 bits are for data, three are for control purposes, and one is for error checking (e.g., a parity bit). This type of frame structure is particularly applicable for use with displays 14 and cameras 16, that transfer 24-bit data (8-bit RGB data), although it can be adapted for use with other types of peripheral devices. If more capacity is needed, the number of channels can be expanded so as to provide, as examples, three differential pairs (D0, D1, D2 channels) and four differential pairs (D0, D1, D2, D3 channels).

It is assumed that the port 20, or some agency connected to the port 20, is operable for encoding data to be transmitted into the preferred PAM-3 MAS format, for deriving a clock from the received signals, for decoding the encoded data and, in accordance with this invention, for detecting an occurrence of an error in the received data.

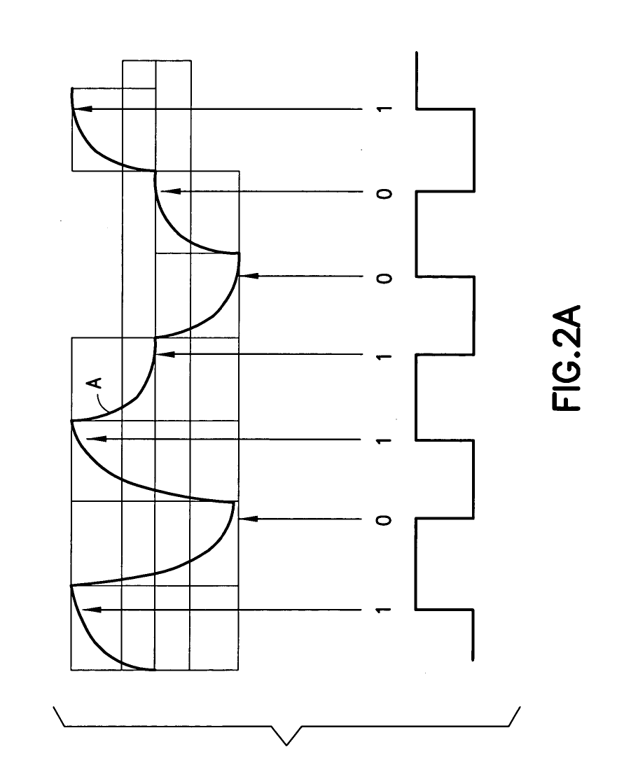

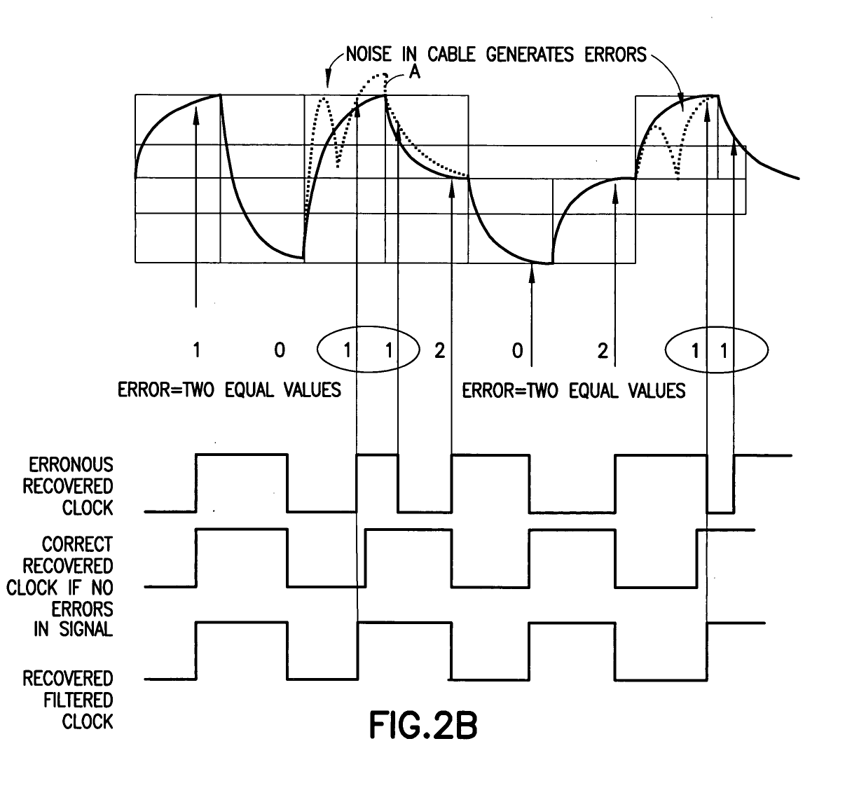

Reference is made to FIG. 2A for showing an exemplary PAM-3 NRZ (Non-Return to Zero) line coding and a recovered clock signal for an ideal, noiseless case. FIG. 2B shows the typical signal reception case containing induced noise, and illustrates clock signal recovery both with and without error filtering. It is assumed that the clock signal is delayed about 65% of the bit period from the input signal comparator level change. The erroneously recovered bit stream is 100111001, while the correct bit stream is 1011001 when the correctly recovered and delayed clock signal is used to sample the input ternary NRZ signal. Note, however, that when the clock signal is erroneously recovered that additional sampling instants of the ternary NRZ signal occur. The line labeled as A in the ternary NRZ signal represents the amplitude at the input to the receiver 20B that is to be measured by two comparators and converted to binary form.

In PAM-3 signaling, as well in PAM-S signaling, consecutive symbols sent along the transmission line from the driver 20A to the receiver 20B are different in order to make it possible for the receiver 20B to detect change in symbol without requiring the use of a continuously running clock. At least one of the comparator outputs is different from previous received symbol if no errors have occurred, such as additional erroneously detected clock edges. As was noted previously, for the exemplary case of PAM-3 the received symbol amplitude level is 0, ½ or 1, and if the symbols are detected correctly then every symbol is different from the previous symbol (and from the next symbol).

In accordance with this invention, in order to detect and filter out erroneously received bit events generated by edge detection and event generation circuitry, two consecutive bits are compared before sending the bits to a serial-to-parallel converter. If the detected symbols are equal, it is assumed that a false triggering has occurred. By the use of this invention the asynchronous type PAM-3 signaling can yield approximately the same performance as more complex PLL-timed sampling.

In the PAM-3 technique of most interest to this invention the amplitude of every symbol is sampled separately based only on the timing information carried by the symbol to be sampled. In this type of signaling method the timing jitter present in the incoming symbols does not induce errors in the amplitude measurement if the bit period is long enough for the amplitude to pass through all voltage comparator reference levels. In a PLL-based system the timing jitter in the incoming symbols increases BER (Bit Error Rate) because the signal is sampled based on the average of several previous pulses.

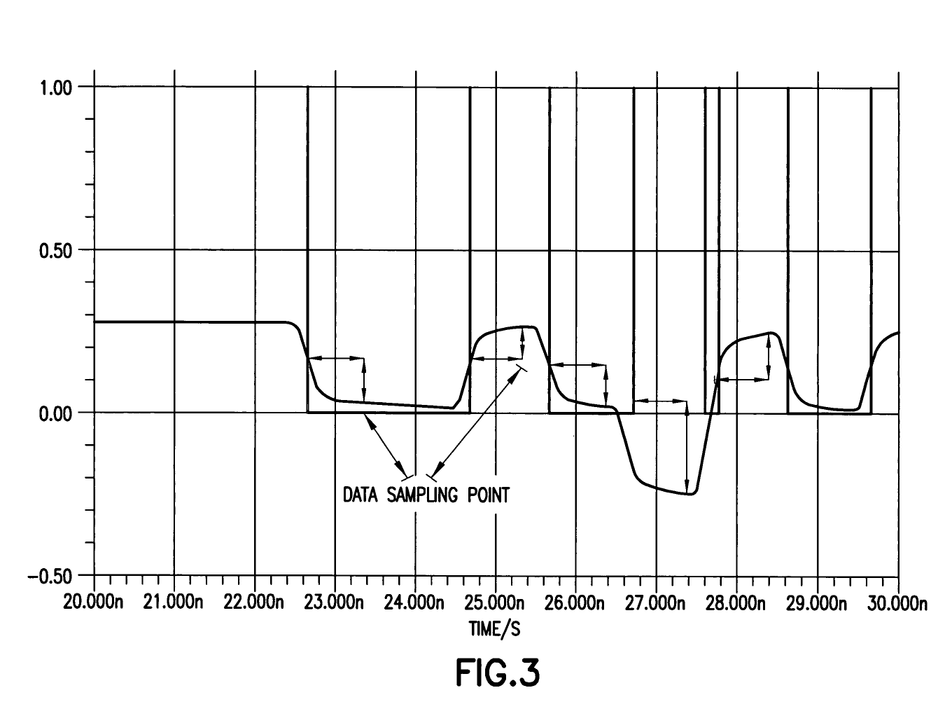

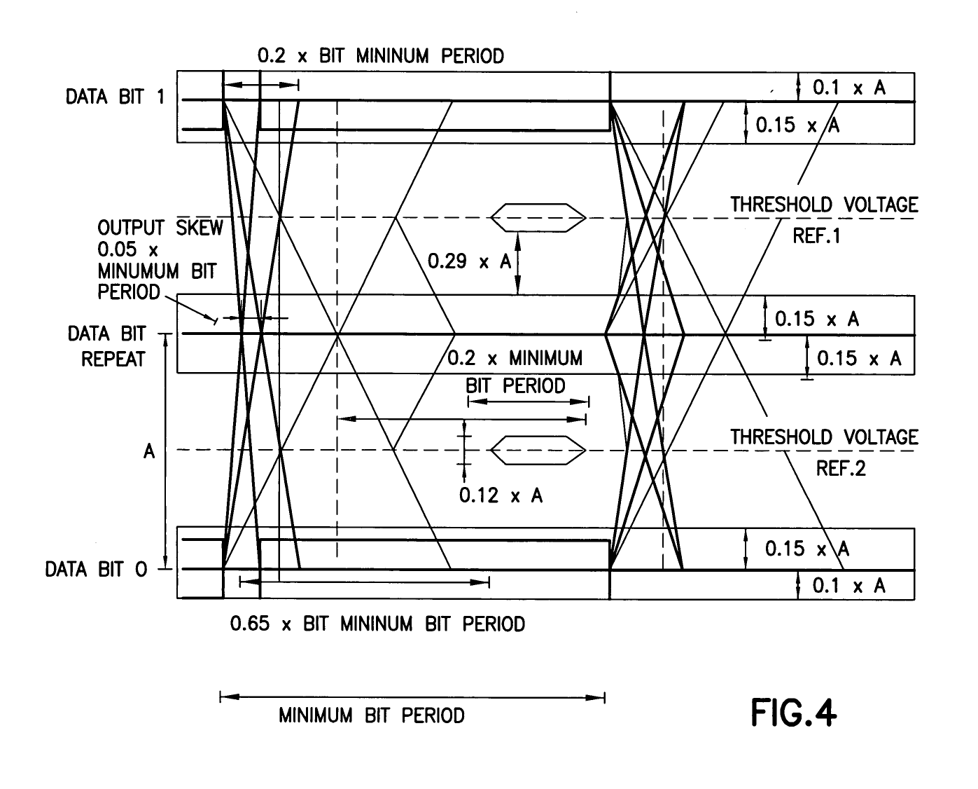

FIG. 3 shows a simulation of a signal waveform and the sampling instants based on the use of voltage comparators, while FIG. 4 illustrates the sampling window of the receiver 20B.

More specifically, FIG. 3 illustrates the amplitude sampling points at 0.65 times the minimum bit period after the received signal has passed the half amplitude point of the signal swing. The timing reference point in the case of two comparator edges is measured from the middle of the comparator level change. FIG. 3 is based on the assumption of the use of a 50 cm long stripline structure using 100 micron wide and 17 micron thick electrically conductive strips, and shows a maximum acceptable signal attenuation at al Gbps (billion bits per second) rate.

FIG. 4 shows the voltage and timing diagram of the driver 20A for one bit period. For the PAM-3 case it is assumed that the signal is encoded to three differential amplitude levels of −300 mV, 0 mV, and +300 mV, and the two receiver 20B comparator threshold reference voltage levels (Ref1 and Ref2) are shown accordingly. The amplitude A is equal to 300 mV in FIG. 4.

In PAM-3 signaling the edge detection and event generator should be fast in order to generate accurate timing, while the data amplitude comparator outputs have a much longer time to stabilize before the next received symbol. However, if the data voltage comparator output is the same as in the previous symbol (during the previous bit time), then an error has occurred in the edge detection and event generation circuit. In this case the input data bit is not shifted out and a clock to step a serial to parallel converter is not generated, thereby filtering out the erroneously received data bit(s).

FIG. 5 is a schematic diagram of the receiver 20B that is constructed in accordance with this invention, and that operates on the principles outlined above. As an overview, the receiver 20B includes first and second voltage comparators 30A, 30B; an event detection and event generation block 32; first and second one-bit shift registers 34A, 34B; two Exclusive OR (XOR) gates (XOR1, XOR2); an OR gate and an AND gate; a toggle flip/flop 36; and a dual rail to binary converter block 38. The output of an XOR is zero if the two input bits are the same, and is a one if the two input bits are different. The event detection and event generation block 32 is assumed to extract the clock signal from the received signal such that there is one active clock edge for each received bit. Preferably the clock signal is delayed so that it has the temporal relationship with respect to the ternary NRZ data that is shown in FIG. 2.

In FIG. 5 it can be seen that the voltage comparators 30A, 30B operate with the voltage references Ref1 and Ref2, respectively, that were shown in FIG. 4. Shift registers 34A, 34B store the result of the current decision by comparators 30A, 30B, respectively, and the result of the most recent previous decision. For the case where both comparators 30A and 30B have the same output state for two consecutive bit periods, which indicates an error condition, the outputs of both XOR1 and XOR2 will simultaneously be zero. This condition will propagate through the OR gate and place a zero at the upper input of the AND gate, thereby disabling the AND gate and preventing the propagation of the Event pulse (clock) from the event detection and event generation block 32 to the one bit shift registers 34A, 34B, thereby inhibiting the loading of the states of the output stage of each of the comparators 30A, 30B. If either or both of the comparator 30A, 30B outputs are different from the previous event, a correct event has occurred. In this case the output of one or both of the XORs will be a one, resulting in a one appearing at the upper input of the AND gate via the OR gate. In this case the pulse output from the event detection and event generation block 32 will propagate to the shift registers (flip/flops) 34A, 34B. The output of the AND gate may thus be considered to provide a filtered high speed clock to the shift registers (flip/flops) 34A, 34B, and to other circuitry as well is so desired. The optional toggle flip/flop 36 provides a filtered double data rate (DDR) high speed clock to other circuitry that may require same.

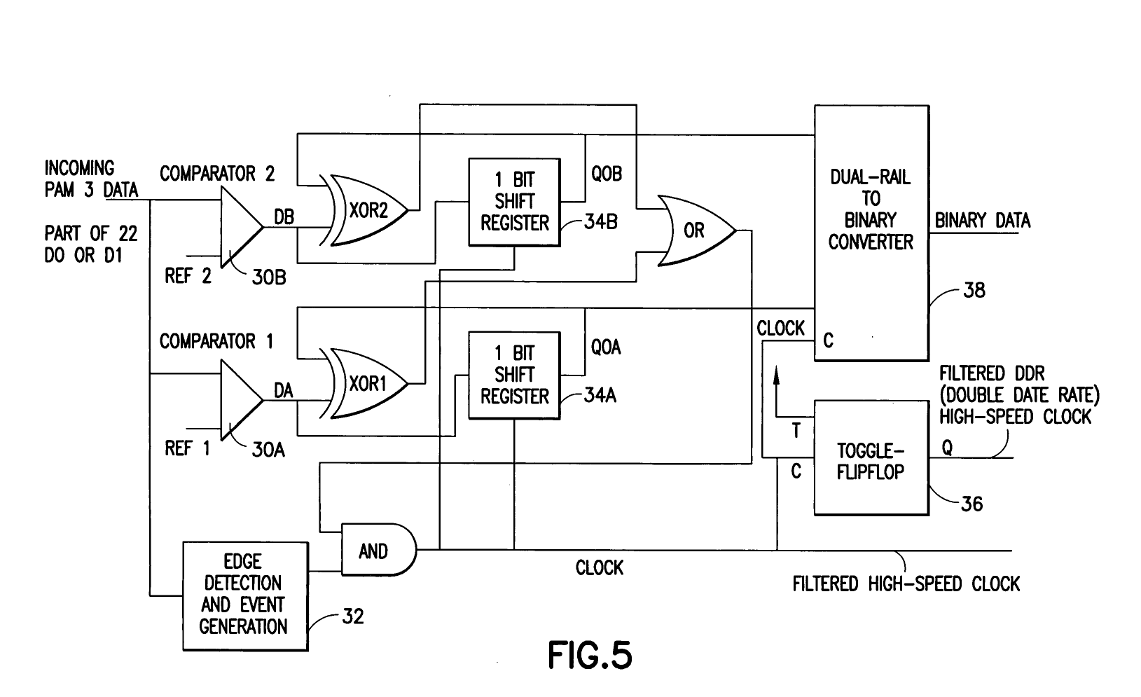

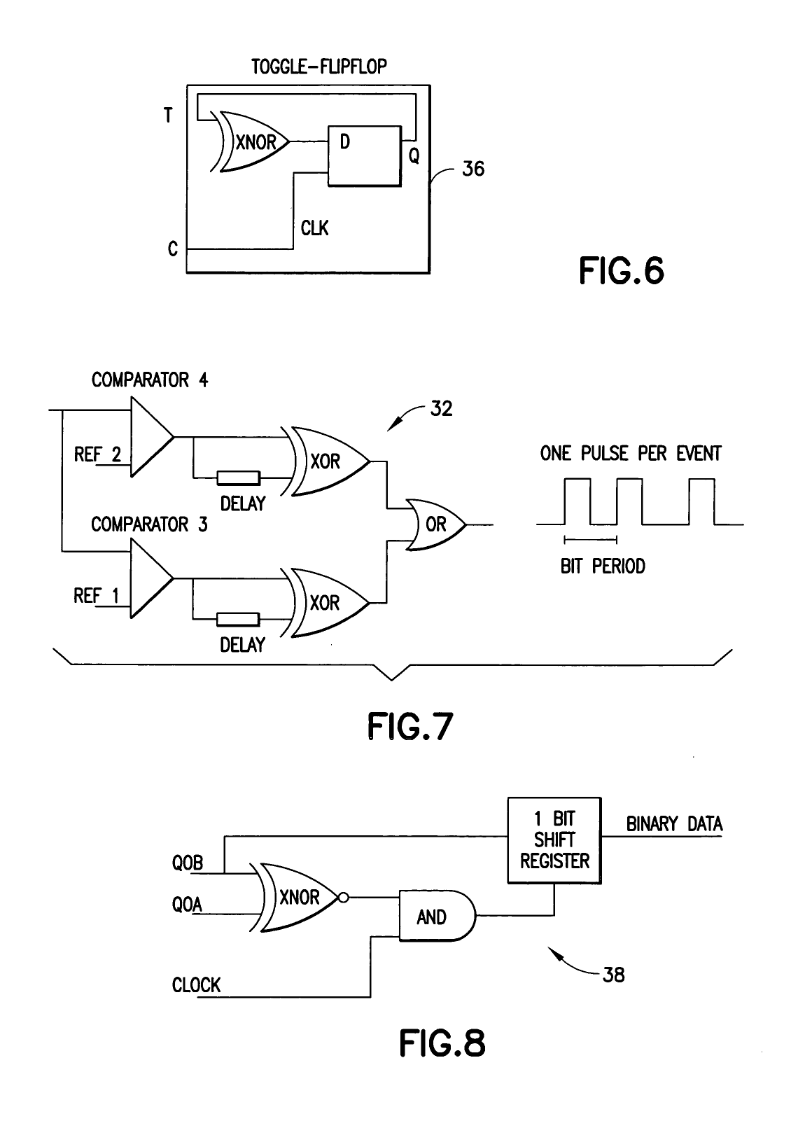

FIG. 6 is a schematic diagram of an embodiment of the toggle flip-flop 36 that forms a part of the error detection circuit of FIG. 5. The toggle flip/flop 36 is basically a D-FF with the Q output fed back to the D input through an XOR.

FIG. 7 is a schematic diagram of an embodiment of the edge detection and event generation circuit 32. This circuit includes additional comparators 3 and 4 that operate with REF1 and REF2, as shown, and that have normal and delayed outputs connected to further XORs. The outputs of the XORs are fed to an OR gate, and ideally provide one pulse per event per bit period. The pulse width of the pulses is set by the amount of delay introduced at the inputs to the XOR gates, and is preferably less than about one half of the bit period. The pulse is generated if one or both of the comparators 3, 4 change state. It should be noted that the outputs of the comparators 30A, 30B could be used as well to drive the two XORs and delay elements, thereby eliminating the comparators 3, 4.

FIG. 8 is a schematic diagram of an embodiment of the dual-rail to binary converter circuit 38. Q0B and Q0A are input to an XNOR gate that feeds an AND gate that also receives the clock signal. The output of the AND clocks a one bit shift register that also receives at its input Q0B. The output is binary data (i.e., two-level data that transitions between, for example, ground and Vdd). This embodiment is useful for line coding when the middle amplitude level state represents a repeated signal. If Q0A and Q0B are both equal to zero, the binary output goes to zero on the rising edge of the clock. If Q0A and Q0B are both equal to one, the binary output goes to one on the rising edge of the clock. If Q0A is equal to one and Q0B is equal to zero, the binary output remains unchanged on the rising edge of the clock, thereby representing the repeated bit value. The state where Q0A equals zero and Q0B is equal to one is not a valid state, as the threshold voltage value (Ref2) of comparator 30B to generate Q0B is greater than the threshold voltage value (Ref1) of comparator 30A to generate Q0A.

The foregoing description of the circuitry shown in FIG. 5 has described a false triggering filter that inhibits errors generated in multiple-amplitude signaling schemes such as PAM-3. However, those skilled in the art should realize that other multiple-amplitude signaling schemes, including but not limited to PAM-S, can also benefit from the use of this invention. By the use of this invention a multiple-amplitude signaling technique that extracts a clock from the incoming data stream can provide error-free performance that approaches that obtainable with more complex and power intensive PLL-based clocking systems.

The circuitry of FIG. 5 exploits the fact that in the preferred MAS technique every correct symbol is different from the previous symbol. The details of a particular implementation depend at least in some degree to how the edge detection and event generation circuit 32 is constructed.

It should be noted that the error filtering circuitry of FIG. 5 cannot in practice eliminate all errors in the received data as, for example, the data could in some cases be incorrect even if the number of detected clock edges is correct. In a typical application though it is usually the case that it is more important to accurately detect and generate the clock signal, as the overall system may be able to tolerate the occasional incorrect data bit.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some example, other similar or equivalent data representation schemes can be used, and the circuitry shown in FIG. 5 may be realized in other embodiments that the specific embodiment that was shown and described above with reference to FIGS. 5, 6, 7 and 8. However, all such and similar modifications of the teachings of this invention will still fall within the scope of this invention.

Furthermore, some of the features of the present invention could be used to advantage without the corresponding use of other features. As such, the foregoing description should be considered as merely illustrative of the principles of the present invention, and not in limitation thereof.

1. A Multi-level Analog Signaling (MAS) method comprising encoding data bits represented by multi-level analog signals; transmitting the encoded data bits over at least one multi-level signal bus between a transmitter and a receiver such that, on said at least one multi-level signal bus, during each data bit period the signal level is required to change from a signal level of an immediately preceding data bit period; generating a clock signal at the receiver from the transmitted encoded data bits such that there is at least one clock edge per data bit period; and detecting an occurrence of an erroneously generated clock edge by detecting that the signal level remains the same for two consecutive data bit periods.

2. A method as in claim 1, further comprising filtering out the erroneously generated clock edge.

3. A method as in claim 1, where the multi-level analog signal comprises a PAM-3 signal where data symbols are encoded using amplitude values 0, ½ and 1, where the ½ middle amplitude value is used to inform the receiver that a newly received symbol is the same as a most recently received previous symbol.

4. A method as in claim 3, where the amplitude values 0, ½ and 1 correspond to amplitude levels of about −300 mV, 0 mV, and +300 mV, respectively, and where said receiver comprises two voltage comparators operating with threshold reference voltage levels Ref1 and Ref2 for detecting a received amplitude level.

5. A method as in claim 4, further comprising storing output states of said two voltage comparators from at least two consecutive data bit periods, and where detecting comprises sensing that the stored output states for each voltage comparator are the same.

6. A method as in claim 1, where at least one of the transmitter and receiver is located within a mobile device having wireless communications capabilities.

7. A Multi-level Analog Signaling (MAS) circuit arrangement comprising a transmitter to encode data bits represented by multi-level analog signals and to send the encoded data bits over at least one multi-level signal bus between said transmitter and a receiver such that, on said at least one multi-level signal bus, during each data bit period the signal level is required to change from a signal level of an immediately preceding data bit period; a receiver circuit for generating a clock signal from received encoded data bits such that there is at least one clock edge per data bit period; and a receiver circuit to detect an occurrence of an erroneously generated clock edge by detecting that the signal level remains the same for two consecutive data bit periods.

8. A circuit arrangement as in claim 7, further comprising a circuit, coupled to an output of said occurrence detecting circuit, to inhibit the propagation of an erroneously generated clock edge.

9. A circuit arrangement as in claim 7, where the multi-level analog signal comprises a PAM-3 signal where data symbols are encoded using amplitude values 0, ½ and 1, where the ½ middle amplitude value is used to inform said receiver that a newly received symbol is the same as a most recently received previous symbol.

10. A circuit arrangement as in claim 9, where the amplitude values 0, ½ and 1 correspond to amplitude levels of about −300 mV, 0 mV, and +300 mV, respectively, and where said receiver comprises two voltage comparators operating with threshold reference voltage levels Ref1 and Ref2 for detecting a received amplitude level.

11. A circuit arrangement as in claim 10, where said occurrence detecting circuit comprises storage for storing output states of said two voltage comparators from at least two consecutive data bit periods, and logic for sensing that the stored output states for each voltage comparator are the same.

12. A circuit arrangement as in claim 7, where at least one of the transmitter and receiver is located within a mobile device having wireless communications capabilities.

13. A circuit arrangement as in claim 12, where the data bits are organized into a multi-bit frame that conveys display data within said mobile device.

14. A circuit arrangement as in claim 13, where the multi-bit frame comprises at least 24 bits for conveying 8-bit Red, Green and Blue data between said transmitter and said receiver.

15. A circuit arrangement as in claim 13, where the multi-bit frame comprises at least 24 bits for conveying 8-bit Red, Green and Blue data between a control unit of a mobile device and a camera of the mobile device.

16. A mobile device comprising a plurality of sub-assemblies coupled together by a plurality of data communication buses connected to ports, where at least one port comprises a Multi-level Analog Signaling (MAS) circuit arrangement comprising a transmitter to encode data bits represented by multi-level analog signals; where a data communications bus that couples the transmitter to a receiver in another port comprises at least one multi-level signal bus for conveying the encoded data bits such that, on each multi-level signal bus, during each data bit period the signal level is required to change from a signal level of an immediately preceding data bit period; said receiver comprising a circuit for generating a clock signal from received encoded data bits such that there is at least one clock edge per data bit period and a circuit to detect an occurrence of an erroneously generated clock edge by detecting that the signal level remains the same for two consecutive data bit periods.

17. A mobile device as in claim 16, further comprising a circuit, coupled to an output of said occurrence detecting circuit, to inhibit the propagation of an erroneously generated clock edge.

18. A mobile device as in claim 16, where the multi-level analog signal comprises a PAM-3 signal where data symbols are encoded using amplitude values 0, ½ and 1, where the ½ middle amplitude value is used to inform said receiver that a newly received symbol is the same as a most recently received previous symbol.

19. A mobile device as in claim 18, where the amplitude values 0, ½ and 1 correspond to amplitude levels of about −300 mV, 0 mV, and +300 mV, respectively, and where said receiver comprises two voltage comparators operating with threshold reference voltage levels Ref1 and Ref2 for detecting a received amplitude level.

20. A mobile device as in claim 19, where said occurrence detecting circuit comprises storage for storing output states of said two voltage comparators from at least two consecutive data bit periods, and logic for sensing that the stored output states for each voltage comparator are the same.

21. A mobile device as in claim 16, where the data bits are organized into a multi-bit frame.

22. A mobile device as in claim 21, where the multi-bit frame comprises at least 24 bits for conveying 8-bit Red, Green and Blue data between said transmitter and said receiver.

23. A mobile device as in claim 21, where the multi-bit frame comprises at least 24 bits for conveying 8-bit Red, Green and Blue data between a cellular engine of said mobile device and a display of said mobile device.

24. A mobile device as in claim 21, where the multi-bit frame comprises at least 24 bits for conveying 8-bit Red, Green and Blue data between a cellular engine of said mobile device and a camera of said mobile device.

25. A mobile device as in claim 16, where one of said sub-assemblies comprises a cellular engine that is coupled to circuitry external to said mobile device via another port and data communications bus.
